(19) United States
(12) Patent Application Publication
(10) Pub. No.: US 2002/0075118 A1
(43) Pub. Date: Jun. 20, 2002

(54) Inductor arrangement

(76) Inventor: Marinus Johannes Josephus Klaassen, Eindhoven (NL)

Correspondence Address: U.S. Philips Corporation, 580 White Plains Road, Tarrytown, NY, 10591, US

(21) Appl. No.: 09/982,268

(22) Filed: Oct. 17, 2001

(30) Foreign Application Priority Data
Oct. 18, 2000 (EP) 00203616.8

(51) Int. Cl. H01F 27/24

(52) U.S. Cl. 336/212

(57) ABSTRACT

An inductor arrangement (100) with a core according to the invention comprises two opposing E-shaped cores (110,111) forming a single core. Due to its E-shaped components, the core has a first outer leg (112), a second outer leg (113) and a middle leg (114). The middle leg preferably has a substantially smaller cross-sectional area than both outer legs. A first inductor coil (101) is wound around the first leg and a second inductor coil (104) is wound around the second leg.

The present invention relates to inductive components for use in electric circuits, and in particular to circuits comprising inductors with magnetic cores.

Electric circuits in many electric appliances cannot do without inductive circuits, least of all voltage transformers and resonance circuits such as filters. Inductors are inherently bulky due to the fact that they comprise coils. In particular, if a high inductance is needed, it is necessary to provide the inductor coil with a magnetic core, usually of ferromagnetic character. Needless to say, this increases the problem of bulkyness.

The problem of bulky inductive circuits can be partly overcome by decreasing the distance between the components. However this leads to problems relating to unwanted magnetic coupling between separate inductors.

Therefore, it is an object of the present invention to find ways in which the problems with prior art inductor arrangements as stated above can be overcome. To this end inductor arrangements are provided in accordance with the appended claims.

An inductor arrangement with a core according to the invention comprises two opposing E-shaped cores forming a single core. Due to its E-shaped components, the core has a first outer leg, a second outer leg and a middle leg. The middle leg preferably has a substantially smaller cross-sectional area than both outer legs. A first inductor coil is wound around the first leg and a second inductor coil is wound around the second leg.

These two inductor coils may form part of, e.g., an electric resonant circuit, such as a LLCC-circuit forming part of a high-voltage generator. In such a circuit, the first coil may be a series resonant coil and the second coil may be a parallel resonant coil.

In operation, the coils produce a magnetic flux through their respective legs. The middle leg of the core acts as a bypass for a magnetic flux, thus keeping unwanted magnetic, and hence electric, coupling between the two coils at a low level. This can be attributed to the resultant effect of the invention. That is, in the middle leg of the core, the magnetic field lines of the first inductor coil and the magnetic field lines of the second inductor coil run in opposite directions. This results in a very low total magnetic flux through the middle leg.

An advantage of the invention is that, due to the low total magnetic flux in the middle leg of the core, the middle leg may have a small cross-sectional area. This in turn means that cores and inductive arrangements comprising such a core may be very compact in size, which in turn may reduce the size of any electric apparatus comprising such an inductive arrangement.

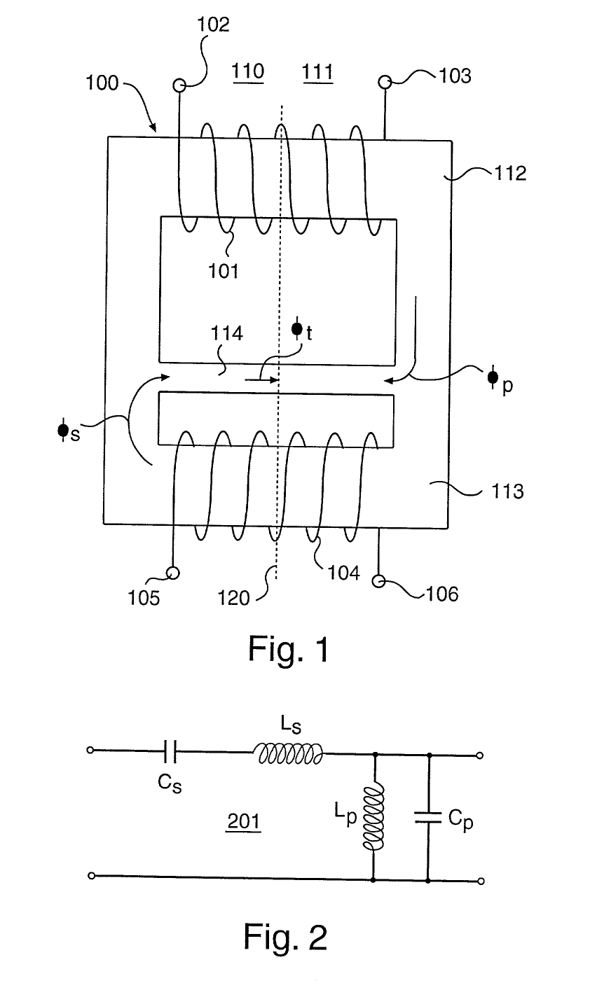

FIG. 1 schematically shows an inductor arrangement according to the present invention.

FIG. 2 schematically shows an electric circuit according to the present invention.

In FIG. 1, a core 100 is shown comprising two E-shaped halves 110,111. The two sides 110,111 may be two or more separate units that are joined together. Or, one single unit as in the present illustration, as indicated by the dashed line 120, and simply referred to as E-shaped cores in order to simplify the description of the arrangement. Moreover, the arrangement illustrated in FIG. 1 is only schematically drawn and not to scale. The advantage of compactness, as stated above, will be understood from this description without the need for explicitly illustrating a compact arrangement.

The two E-shaped cores 110,111 both have respective first and second outer legs that together form a first outer leg 112 and a second outer leg 113 of the resultant core 100. A middle leg 114 of the core 100 is located between the two outer legs 112,113, as illustrated. The middle leg 114 is illustrated as being thinner than the outer legs 112,113. This is intentional and serves to illustrate the fact that the cross-sectional area, which is not explicitly illustrated in FIG. 1, of the middle leg 114 is smaller, preferably significantly smaller, than the cross-sectional area of the two outer legs 112,113.

A first inductor coil 101 with connector terminals 102,103 is wound around the first leg 112. A second inductor coil 104 with connector terminals 105,106 is wound around the second leg 113.

In operation, the coils 101,104 produce a magnetic flux Φp and Φs, respectively, through their respective legs 112,113. The middle leg 114 of the core acts as a bypass for magnetic flux, thus keeping unwanted magnetic, and hence electric, coupling between the two coils 101,104 at a low level. In the middle leg 114 of the core, the field lines of the magnetic flux Φp of the first inductor coil 101 and the field lines of the magnetic flux Φs of the second inductor coil run in opposite directions. This results in a very low total magnetic flux Φt through the middle leg.

FIG. 2 illustrates a resonance circuit 201 of the LLCC-type comprising two inductors Ls and Lp as well as two capacitors Cs and Cp. In a preferred embodiment, the two inductor coils of the circuit 201 are provided with an inductor core as illustrated in FIG. 1.

1. Inductor core comprising two opposing E-shaped cores (110,111) forming a single core having a first outer leg (112), a second outer leg (113) and a middle leg (114), said middle leg (114) having a substantially smaller cross-sectional area than both outer legs.

2. Inductor core according to claim 1, wherein the opposing E-shaped cores are formed from one single unit.

3. Inductor core according to claim 1, wherein the opposing E-shaped cores are formed from at least two separate units.

4. Inductor arrangement (100), comprising a core according to any one of claims 1-3, a first inductor coil (101) wound around the first outer leg (112) and a second inductor coil (104) wound around the second outer leg (113).

5. Electric circuit (201), comprising an inductor arrangement according to claim 4.

6. Electric circuit (201) according to claim 5, wherein the first inductor coil (101) is a series-resonant coil and the second inductor coil (104) is a parallel-resonant coil, both coils (101,104) forming part of a LLCC-circuit.
